(19) United States
(12) Patent Application Publication
(10) Pub. No.: US 2009/0099910 A1
(43) Pub. Date: Apr. 16, 2009

(54) SYSTEM AND METHOD FOR MANAGING ELECTRONIC ADVERTISING RESPONSIVE TO TRAFFIC CONGESTION

(75) Inventors: Aaron E. Merkin, Holly Springs, NC (US); William G. Pagan, Durham, NC (US)

Correspondence Address: HOFFMAN WARNICK LLC, 75 STATE STREET, 14TH FLOOR, ALBANY, NY, 12207, US

(73) Assignee: International Business Machines Corporation, Armonk, NY (US)

(21) Appl. No.: 11/870,634

(22) Filed: Oct. 11, 2007

(51) Int. Cl. G06Q 30/00; G01C 21/00; G06F 17/30; G06F 17/40

(52) U.S. Cl. 705/14; 701/118

(57) ABSTRACT

A system and method for counting vehicle traffic, for providing electronic advertising, for providing a billing system, and for providing an auction system having the following features: enabling the owner of an electronic advertising display device to charge advertisers per number of vehicles which pass the advertisement; enabling advertisers to bid to have their respective advertisement shown for a particular congestion level and dynamically changing the advertisement shown; cycling through a series of advertisements and based on calculated average vehicle speed; determining how many of the advertisements were likely viewed by the occupants of a vehicle; and calculating the average number of viewers of the advertisements.

### BACKGROUND OF THE INVENTION

1. Field of the Invention

The present invention generally relates to electronic advertising. Specifically, the present invention provides a system and method for managing electronic advertising responsive to traffic congestion.

2. Related Art

New technologies have made it economically viable to deploy electronic advertisements in locations where print media was used exclusively previously. One of the primary differences between electronic and print media is that the advertisement displayed by the electronic media can be varied with a frequency that is not economically viable with print. That is, the same electronic billboard can display different advertisements for the same or different advertisers in a regular or irregular pattern. For example, the same billboard may display three advertisements and cycle through them at 30 second intervals. The ability to display multiple advertisements from the same billboard introduces several unique problems and opportunities. In the case of a roadside billboard, an advertiser may be willing to pay more to have his advertisement shown when traffic congestion is high and there are more vehicles traveling by the sign. Alternately, the owner of the billboard may bill the advertiser for each potential viewer of the advertisement.

While the art teaches that there are electronic billboards that can count viewers, there is a deficiency in the state of the art whereby a viewer can stand in front of the sign for 30 seconds and be weighed just as heavily as someone who stands in front of the sign for 30 minutes. Likewise, in the case of vehicles, a vehicle passing by a billboard at 60 MPH is counted the same as a vehicle stuck in standstill congestion in front of the billboard. It is quite likely that the advertiser would be willing to pay more per viewer and the billboard owner would be able to charge more for the use of the billboard if the viewer is in front of the advertisement longer. This is not possible to determine using prior art techniques and systems.

Therefore, there exists a need for a solution that solves at least one of the deficiencies of the related art.

### SUMMARY OF THE INVENTION

In general, the present invention provides a way to integrate mechanisms for counting vehicle traffic, for providing electronic advertising, for providing a billing system, and for providing an auction system to provide the following features:
enabling the owner of an electronic advertising display device to charge advertisers per number of vehicles which pass the advertisement on an adjacent roadway when their respective advertisement is the sole advertisement shown;
enabling advertisers to bid to have their respective advertisement shown for a particular congestion level on the adjacent roadway and dynamically changing the advertisement shown as detected congestion levels vary;
cycling through a series of advertisements and based on calculated average vehicle speed;
determining how many of the advertisements were likely viewed by the occupants of a vehicle, such that when per vehicle billing is utilized, the advertisers are only charged for a vehicle if their respective advertisement was visible to the occupants; and
calculating the average number of viewers of the advertisements as a function of the traffic congestion.

In summary, the present invention is a system and method for measuring the rate at which traffic moves past, showing an ad for a weighted ratio of seconds per viewer, and billing advertisers accordingly via a singular solution.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a system for managing electronic advertising responsive to traffic congestion according to the present invention.

FIG. 2 shows an illustrative embodiment of the method managing electronic advertising responsive to traffic congestion according to the present invention.

FIG. 3 shows another illustrative embodiment of the method managing electronic advertising responsive to traffic congestion according to the present invention.

FIG. 4 shows a data processing system suitable for storing and/or executing program code according to the present invention.

FIG. 5 shows an illustrative embodiment of a network for supporting the system and method of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

The present invention provides a system and method for measuring the rate at which traffic moves past, showing an ad for a weighted ratio of seconds per viewer, and billing advertisers accordingly via a singular solution.

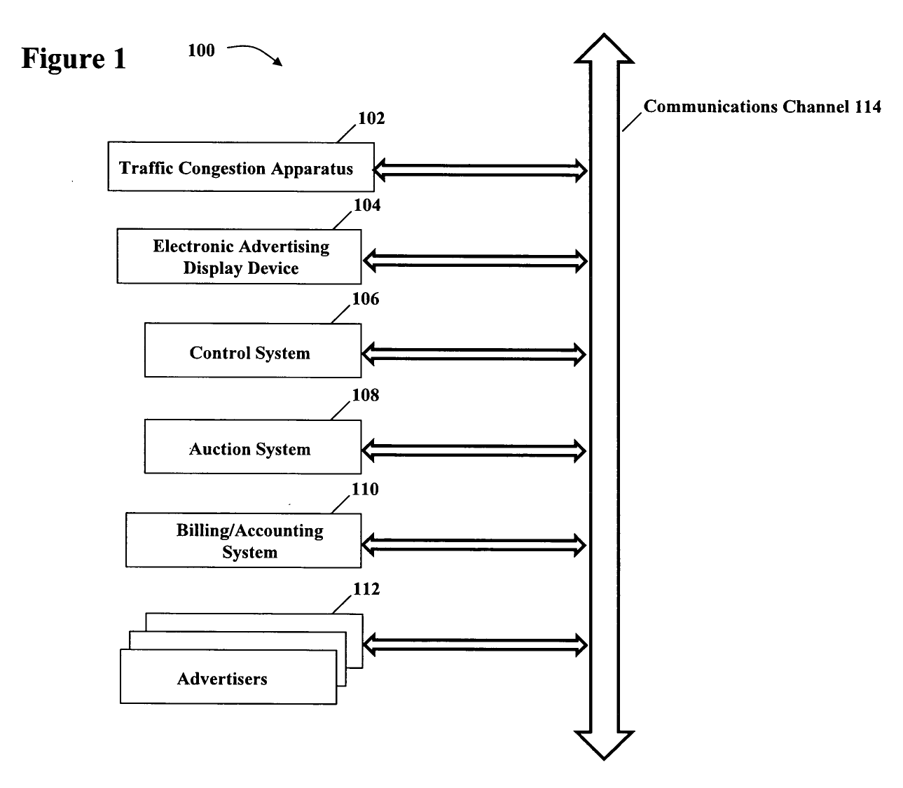

As shown in FIG. 1, the present invention 100 consists of the following parts:

a) a traffic congestion detection apparatus 102 (capable of estimating aggregate flow and/or individual vehicle count);
b) electronic advertising display device 104 such as a video billboard;
c) a control system 106 that manages the currently displayed advertisement;
d) an auction system 108 that enables advertisers to bid for display of their respective advertisement based on congestion/vehicle count;
e) a billing/accounting system 110 for calculating charges based on frequency with which advertisement is displayed, and/or the number of vehicles that pass within visible range of the advertising media; and
f) one or more advertisers 112 with advertisements (g0, g1, g2 . . . gN) to display on the electronic advertising display device, all, a) through f), connected to a communications channel 114.

The system works as follows: the advertisements g0, g1, g2 . . . gN from advertisers 112 are displayed on electronic advertising display device 104. The traffic congestion detection apparatus 102 communicates with control system 106 providing information on the current traffic congestion level. The control system 106 relays congestion information to auction system 108, and one or more advertisers 112 place bids to have their advertisement (g0, g1, g2 . . . gN) shown, with higher congestion levels presumably considered more valuable than lower congestion levels. As the congestion levels reported by traffic congestion detection apparatus 102 to control system 106, and control system 106 updates the advertisement (g0, g1, g2 . . . gN) shown on electronic advertising display device 104.

In an alternate embodiment, traffic congestion detection apparatus 102 maintains an absolute count of the number of vehicles which pass electronic advertising display device 104. Control system 106 controls electronic advertising display device 104, causing electronic advertising display device 104 to cycle through one or more displayed advertisements. As control system 106 causes electronic advertising display device 104 to transition from g0 to g1, control system 106 queries traffic congestion detection apparatus 102 to determine the total number of vehicles that have passed electronic advertising display device 104 to date (T0). As control system 106 causes electronic advertising display device 104 to transition from g1 to g2, control system 106 queries traffic congestion detection apparatus 102 to determine the total number of vehicles that have passed electronic advertising display device 104 to date (T1). Control system 106 subtracts T0 from T1, giving the total number of vehicles that have passed electronic advertising display device 104 while g1 was displayed. Control system 106 passes this total to billing/accounting system 110. Billing/accounting system 110 calculates the total charge to one or more advertisers 112 by multiplying the charge per vehicle by the number of vehicles reported by control system 106.

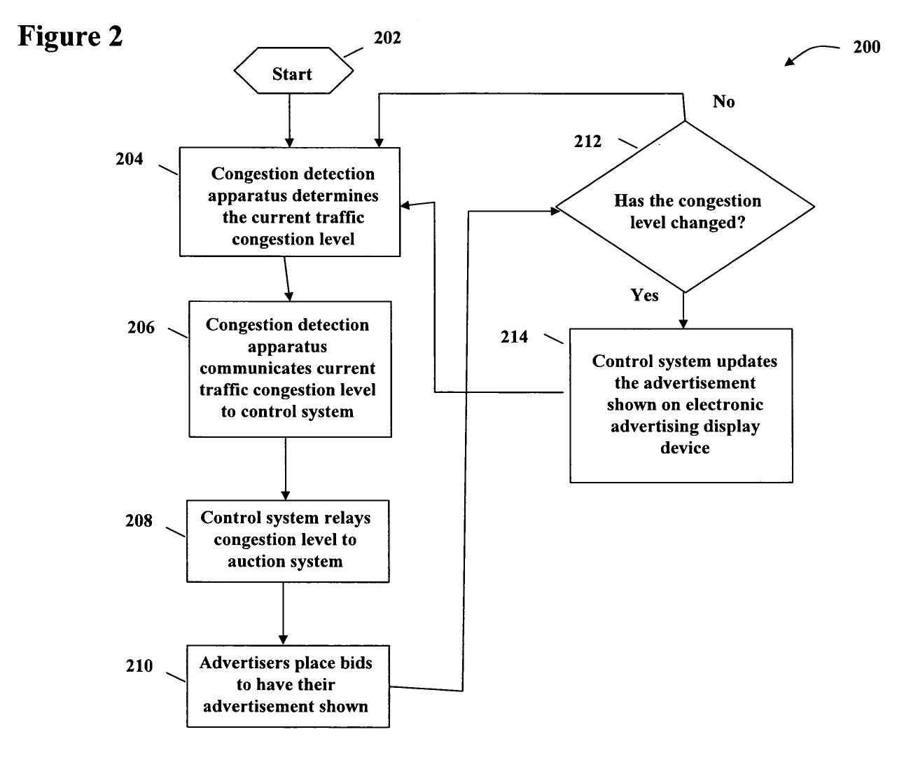

FIG. 2 illustrates an embodiment 200 of the method of the present invention which begins at step 202. At step 204, congestion detection apparatus 102 determines the current traffic congestion level. At step 206, congestion detection apparatus 102 communicates with control system 106 providing information on the current traffic congestion level. At step 208, the control system 106 relays congestion information to auction system 108, and, at step 210, one or more advertisers 112 place bids to have their advertisement (g0, g1, g2 . . . gN) shown, with higher congestion levels presumably considered more valuable than lower congestion levels. At step 212, traffic congestion detection apparatus 102 determines whether the congestion levels have changed and, if so, it is reported to control system 106 and, at step 214, control system 106 updates the advertisement (g0, g1, g2 . . . gN) shown on electronic advertising display device 104. The method continuously repeats returning to step 204.

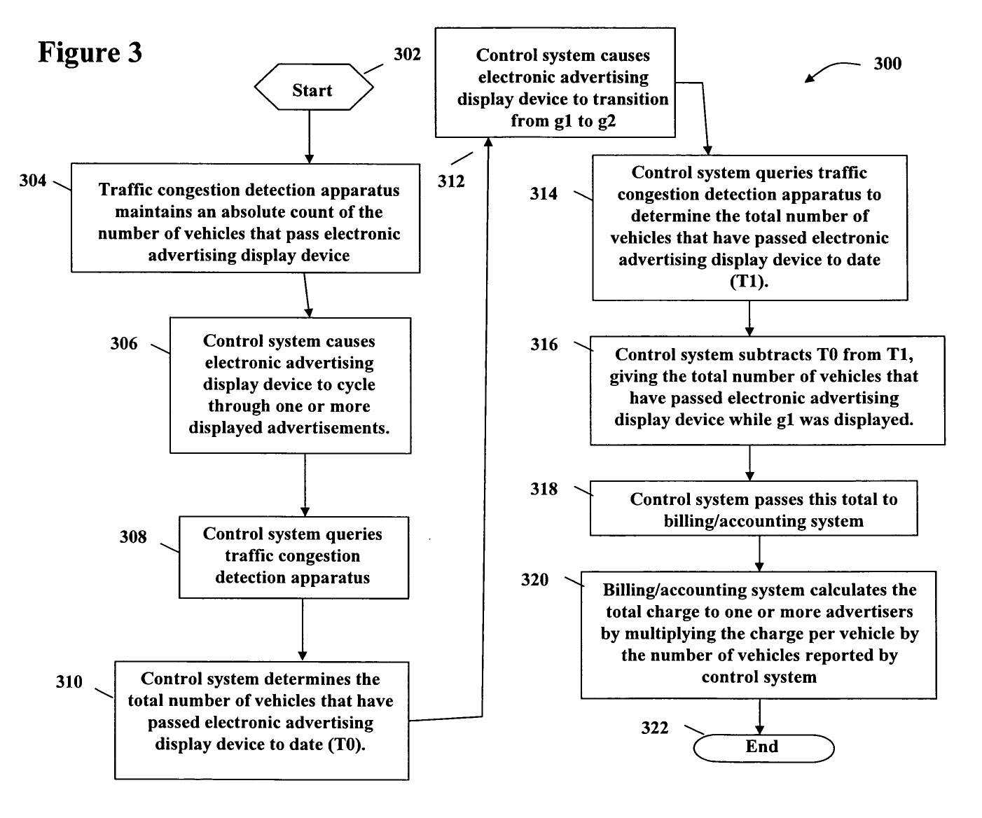

FIG. 3 illustrates another embodiment 300 of the method of the present invention which begins at step 302. At step 304, traffic congestion detection apparatus 102 maintains an absolute count of the number of vehicles which pass electronic advertising display device 104. At step 306, control system 106 controls electronic advertising display device 104, causing electronic advertising display device 104 to cycle through one or more displayed advertisements. At steps 308 and 310, as control system 106 causes electronic advertising display device 104 to transition from g0 to g1, control system 106 queries traffic congestion detection apparatus 102 to determine the total number of vehicles that have passed electronic advertising display device 104 to date (T0). At step 312, as control system 106 causes electronic advertising display device 104 to transition from g1 to g2, at step 314, control system 106 queries traffic congestion detection apparatus 102 to determine the total number of vehicles that have passed electronic advertising display device 104 to date (T1). At step 316, control system 106 subtracts T0 from T1, giving the total number of vehicles that have passed electronic advertising display device 104 while g1 was displayed. At step 318, control system 106 passes this total to billing/accounting system 110. At step 320, billing/accounting system 110 calculates the total charge to one or more advertisers 112 by multiplying the charge per vehicle by the number of vehicles reported by control system 106.

It should be understood that the present invention is typically computer-implemented via hardware and/or software. As such, and client systems and/or servers will include computerized components as known in the art. Such components typically include (among others), a processing unit, a memory, a bus, input/output (I/O) interfaces, external devices, etc. It should also be understood that although a specific embodiment involving a system and method for measuring the rate at which traffic moves past, showing an ad for a weighted ratio of seconds per viewer, and billing advertisers accordingly via a singular solution has been depicted and described, the present invention could be implemented in conjunction with any type of data processing system.

While shown and described herein as a system and method for measuring the rate at which traffic moves past, showing an ad for a weighted ratio of seconds per viewer, and billing advertisers accordingly via a singular solution, it is understood that the invention further provides various alternative embodiments. For example, in one embodiment, the invention provides a computer-readable/useable medium that includes computer program code to enable a computer infrastructure for measuring the rate at which traffic moves past, showing an ad for a weighted ratio of seconds per viewer, and billing advertisers accordingly via a singular solution. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory and/or storage system (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a computer-implemented method for measuring the rate at which traffic moves past, showing an ad for a weighted ratio of seconds per viewer, and billing advertisers accordingly. In this case, a computerized infrastructure can be provided and one or more systems for performing the process steps of the invention can be obtained (e.g., created, purchased, used, modified, etc.) and deployed to the computerized infrastructure. To this extent, the deployment of a system can comprise one or more of (1) installing program code on a computing device, such as computer system from a computer-readable medium; (2) adding one or more computing devices to the computer infrastructure; and (3) incorporating and/or modifying one or more existing systems of the computer infrastructure to enable the computerized infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

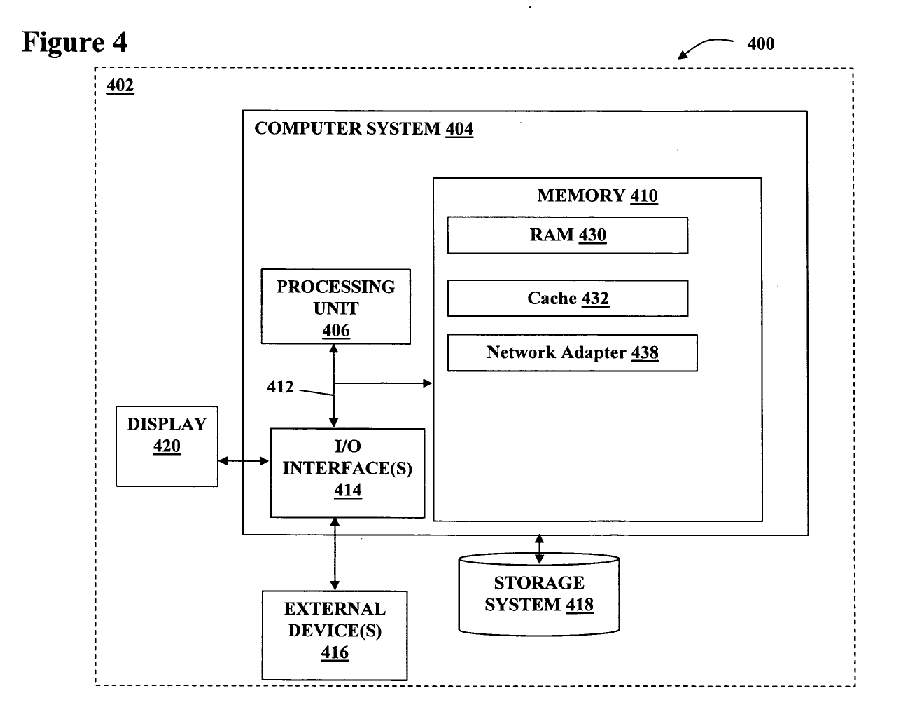

A data processing system which could be used as part of the present invention, such as that system 400 shown in FIG. 4, suitable for storing and/or executing program code will include at least one processor (processing unit 406) coupled directly or indirectly to memory elements through a system bus. The memory elements can include local memory (RAM 430) employed during actual execution of the program code, bulk storage (storage 418), and cache memories (cache 432) which provide temporary storage of at least some program code in order to reduce the number of times code must be retrieved from bulk storage during execution. Input/output or I/O devices (external devices 416) (including but not limited to keyboards, displays, pointing devices, etc.) can be coupled to the system either directly or through intervening I/O controllers (I/O Interface 414).

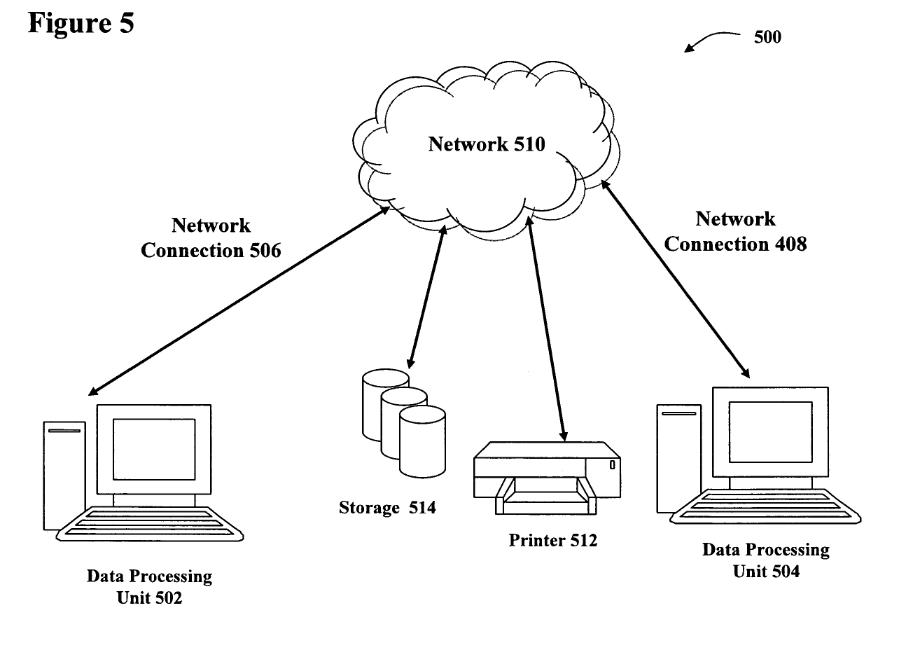

Network adapters (network adapter 438) may also be coupled to the system to enable the data processing system (as shown in FIG. 5, data processing unit 502) to become coupled to other data processing systems (data processing unit 504) or remote printers (printer 512) or storage devices (storage 514) through intervening private or public networks (network 510). (A computer network is composed of multiple computers connected together using a telecommunication system for the purpose of sharing data, resources and communication. For more information, see http://historyoftheinternet.org/). Modems, cable modems and Ethernet cards are just a few of the currently available types of network adapters. (A network card, network adapter or NIC (network interface card) is a piece of computer hardware designed to allow computers to communicate over a computer network. It is both an OSI layer 1 (physical layer) and layer 2 (data link layer) device, as it provides physical access to a networking medium and provides a low-level addressing system through the use of MAC addresses. It allows users to connect to each other either by using cables or wirelessly.)

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A system for managing electronic advertising of advertisements from advertisers responsive to traffic congestion of vehicles comprising:
a) a traffic congestion detection apparatus for estimating aggregate vehicle flow and/or individual vehicle count and determining congestion level;
b) electronic advertising display device such as a video billboard for displaying one or more advertisements from one or more advertisers;
c) a control system for managing the currently displayed one or more advertisements;
d) an auction system for enabling advertisers to bid for display of their respective advertisement based on the determined congestion level, individual vehicle count or aggregate vehicle flow; and
e) a billing/accounting system for calculating charges based on frequency with which advertisement is displayed, and/or the determined congestion level, individual vehicle count or aggregate vehicle flow that pass within visible range of the advertising media.

2. The system of claim 1 further comprising a communications channel connected to each element for allowing the elements to communicate with each another.

3. The system of claim 2 further comprising advertisements g0, g1, g2 . . . gN provided by the advertisers for being displayed on the electronic advertising display device.

4. The system of claim 3 wherein the traffic congestion detection apparatus communicates with the control system providing information on the current traffic congestion level.

5. The system of claim 4 wherein the control system relays congestion information to the auction system, and the one or more advertisers place bids to have their advertisement (g0, g1, g2 . . . gN) shown.

6. The system of claim 5 wherein, as the congestion levels reported by the traffic congestion detection apparatus to the control system change, and the control system updates the advertisement (g0, g1, g2 . . . gN) shown on electronic advertising display device.

7. A method for managing electronic advertising of advertisements from advertisers responsive to traffic congestion of vehicles, the method being run in a system comprising a traffic congestion detection apparatus for estimating aggregate vehicle flow and/or individual vehicle count and determining congestion level, electronic advertising display device such as a video billboard for displaying one or more advertisements from one or more advertisers, a control system for managing the currently displayed one or more advertisements, an auction system for enabling advertisers to bid for display of their respective advertisement based on the determined congestion level, individual vehicle count or aggregate vehicle flow, a billing/accounting system for calculating charges based on frequency with which advertisement is displayed, and/or the determined congestion level, individual vehicle count or aggregate vehicle flow that pass within visible range of the advertising media, and a communications channel connected to each element for allowing the elements to communicate with each another, the method comprising the steps of:
a) displaying advertisements g0, g1, g2 . . . gN provided by the advertisers on the electronic advertising display device;
b) determining the current traffic congestion level by the traffic congestion detection;
c) communicating the current traffic congestion level by the traffic congestion detection apparatus to the control system;
d) relaying, by the control system, the congestion information to the auction system; and
e) receiving, from the one or more advertisers, bids to have their respective advertisement shown.

8. The method of claim 7 further comprising the step of, as the congestion levels reported by the traffic congestion detection apparatus to the control system change, updating, by the control system the advertisement (g0, g1, g2 . . . gN) shown on electronic advertising display device.

9. A method for managing electronic advertising of advertisements from advertisers responsive to traffic congestion of vehicles, the method being run in a system comprising a traffic congestion detection apparatus for estimating aggregate vehicle flow and/or individual vehicle count and determining congestion level, electronic advertising display device such as a video billboard for displaying one or more advertisements from one or more advertisers, a control system for managing the currently displayed one or more advertisements, an auction system for enabling advertisers to bid for display of their respective advertisement based on the determined congestion level, individual vehicle count or aggregate vehicle flow, a billing/accounting system for calculating charges based on frequency with which advertisement is displayed, and/or the determined congestion level, individual vehicle count or aggregate vehicle flow that pass within visible range of the advertising media, and a communications channel connected to each element for allowing the elements to communicate with each another, the method comprising the steps of:
a) maintaining, by the traffic congestion detection apparatus, an absolute count of the number of vehicles which pass the electronic advertising display device;
b) controlling, by the control system, the electronic advertising display device;
c) causing electronic advertising display device to cycle through one or more displayed advertisements; and
d) determining, by the control system, the total number of vehicles which have passed electronic advertising display device while an advertisement has been displayed.

10. The method of claim 9 wherein step d comprises the steps of determining, by the control system, the total number of vehicles which have passed electronic advertising display device while advertisement g1 is displayed, determining, by the control system, the total number of vehicles which have passed electronic advertising display device while advertisement g1 and g2 are displayed and subtracting the total number of vehicles which have passed electronic advertising display device while advertisement g1 was displayed from the total number of vehicles which have passed electronic advertising display device while advertisement g1 and g2 are displayed thereby determining the total number of vehicles which have passed electronic advertising display device while advertisement g2 is displayed.

11. The method of claim 10 further comprising the step of the control system passing this total to billing/accounting system.

12. The method of claim 11 further comprising the step of the billing/accounting system calculating the total charge to one or more advertisers by multiplying the charge per vehicle by the number of vehicles reported by control system.

13. A computer program product in a computer readable medium for operating in a system comprising a network I/O, a CPU, and one or more databases, for implementing a method for managing electronic advertising of advertisements from advertisers responsive to traffic congestion of vehicles, the system further comprising a traffic congestion detection apparatus for estimating aggregate vehicle flow and/or individual vehicle count and determining congestion level, electronic advertising display device such as a video billboard for displaying one or more advertisements from one or more advertisers, a control system for managing the currently displayed one or more advertisements, an auction system for enabling advertisers to bid for display of their respective advertisement based on the determined congestion level, individual vehicle count or aggregate vehicle flow, a billing/accounting system for calculating charges based on frequency with which advertisement is displayed, and/or the determined congestion level, individual vehicle count or aggregate vehicle flow that pass within visible range of the advertising media, and a communications channel connected to each element for allowing the elements to communicate with each another, the method comprising the steps of:
a) maintaining, by the traffic congestion detection apparatus, an absolute count of the number of vehicles which pass the electronic advertising display device;
b) controlling, by the control system, the electronic advertising display device;
c) causing electronic advertising display device to cycle through one or more displayed advertisements; and
d) determining, by the control system, the total number of vehicles which have passed electronic advertising display device while an advertisement has been displayed.

14. The computer program product of claim 13 wherein step d of the method comprises the steps of determining, by the control system, the total number of vehicles which have passed electronic advertising display device while advertisement g1 is displayed, determining, by the control system, the total number of vehicles which have passed electronic advertising display device while advertisement g1 and g2 are displayed and subtracting the total number of vehicles which have passed electronic advertising display device while advertisement g1 was displayed from the total number of vehicles which have passed electronic advertising display device while advertisement g1 and g2 are displayed thereby determining the total number of vehicles which have passed electronic advertising display device while advertisement g2 is displayed.

15. The computer program product of claim 14 wherein the method further comprises the step of the control system passing this total to billing/accounting system.

16. The computer program product of claim 15 wherein the method further comprises the step of the billing/accounting system calculating the total charge to one or more advertisers by multiplying the charge per vehicle by the number of vehicles reported by control system.
